(19) United States
(12) Patent Application Publication
(10) Pub. No.: US 2013/0166478 A1
(43) Pub. Date: Jun. 27, 2013

(54) Content Management Apparatus

(71) Applicant: YAMAHA CORPORATION, Hamamatsu-shi (JP)

(72) Inventors: Kiyohisa SUGII, Hamamatsu-shi (JP); Yuji KOIKE, Yokohama-shi (JP)

(73) Assignee: YAMAHA CORPORATION, Hamamatsu-shi (JP)

(21) Appl. No.: 13/725,022

(22) Filed: Dec. 21, 2012

(30) Foreign Application Priority Data
Dec. 27, 2011 (JP) 2011-286166

(51) Int. Cl. G06Q 30/00

(52) U.S. Cl. CPC G06Q 30/00
USPC 705/400

(57) ABSTRACT

When modification information acquired by an acquisition unit indicates that content is a modification of other content, a computation unit calculates charge of the content by summing a charge of the other content and a price of the content and stores charge information indicating the calculated charge in a storage unit in correspondence to the content. When the modification information corresponding to used content indicates that the used content is a modification of other content, an addition unit adds a price of the other content to a distributed amount allocated to a creator who creates the other content.

### BACKGROUND OF THE INVENTION

1. Technical Field of the Invention

The present invention relates to an apparatus for managing content.

2. Description of the Related Art

Recently, derivative works have been created using original content. Japanese Patent Application Publication No. 2008-165625 discloses a system in which distribution of profits is performed objectively and fairly even in the case of joint creation or derivative content.

However, in the system disclosed in Japanese Patent Application Publication No. 2008-165625, a content access charge is distributed to each content creator according to a royalty distribution rate, and thus a portion per person decreases as the number of content creators increases. Accordingly, a content creator may not be sufficiently paid for his/her content.

### SUMMARY OF THE INVENTION

An object of the present invention is to provide a system for distributing a set price to each of a creator of content and a creator of a modification of the content when the modified content is used.

The invention provides a content management apparatus comprising: an acquisition unit that acquires content identification information identifying content created by a creator, price information indicating a price set for the content, and modification information indicating whether the content is a modification of other content; a storage unit that stores the content identification information, the price information and the modification information, which are acquired by the acquisition unit, and also stores distributed amount information indicating a distributed amount allocated to the creator who creates the content in such a manner that the content, the price, the modification information and the distributed amount correspond to one another; a computation unit that calculates, based on the price of the content identified by the content identification information stored in the storage unit, a charge which is charged to a user when the content is used by the user, and that stores charge information indicating the calculated charge in the storage unit in correspondence to the content created by the creator when the modification information acquired by the acquisition unit indicates that the content is not a modification of the other content; and an addition unit that adds the price of the content to the distributed amount corresponding to the content when the content is used, thereby updating the distributed amount information stored in the storage unit. When the modification information acquired by the acquisition unit indicates that the content is a modification of the other content, the computation unit calculates the charge of the content by summing a charge of the other content and the price of the content and stores charge information indicating the calculated charge in the storage unit in correspondence to the content. When the modification information corresponding to the used content indicates that the used content is a modification of other content, the addition unit adds a price of the other content to a distributed amount corresponding to the other content.

In a preferred aspect of the present invention, when the modification information acquired by the acquisition unit indicates that the content is not a modification of the other content and the price corresponding to the content is a predetermined amount, the computation unit calculates the charge of the content by summing the predetermined amount and a predetermined maintenance fee.

In a preferred aspect of the present invention, the computation unit sets the charge free when the modification information acquired by the acquisition unit indicates that the content is not a modification of the other content and the price of the content is free. Further, the computation unit calculates the charge of the content by summing the price of the content and a predetermined maintenance fee when the modification information acquired by the acquisition unit indicates that the content is a modification of the other content, the charge of the other content is free, and the price of the content is not free.

In a preferred aspect of the present invention, the acquisition unit acquires the content identification information identifying content which is music or tracks constituting the music. In such a case, the acquisition unit acquires the content identification information, the price information and the modification information for each of the tracks of the music.

Further, the acquisition unit acquires the content identification information identifying content which is audio data representing a synthesized voice. Specifically, the acquisition unit acquires the content identification information identifying content which is modified from other content by applying sound processing to the other content. The sound processing applied to the other content includes volume adjustment, effect processing and voice synthesis.

According to the present invention, it is possible to distribute a set price to each of a creator of content and a creator of a modification of the content when the modified content is used.

### BRIEF DESCRIPTION OF THE DRAWINGS

FIG. 1 illustrates a configuration of a content transaction system according to an embodiment of the invention.

FIG. 2 illustrates a configuration of a server.

FIG. 3 shows an exemplary content management table.

FIG. 4 shows an exemplary distribution management table.

FIG. 5 illustrates a configuration of a client device.

FIG. 6 illustrates a functional configuration of the server.

FIG. 7 is a sequence chart illustrating a content registration procedure.

FIG. 8 shows an exemplary registration screen.

FIG. 9 is a sequence chart illustrating a content purchase procedure.

FIG. 10 shows an exemplary content list screen.

FIG. 11 is a sequence chart illustrating a content modification procedure.

FIG. 12 shows an exemplary edit screen.

FIG. 13 illustrates a voice synthesis procedure.

FIG. 14 shows an exemplary distribution management table.

### DETAILED DESCRIPTION OF THE INVENTION

### 1. Configuration

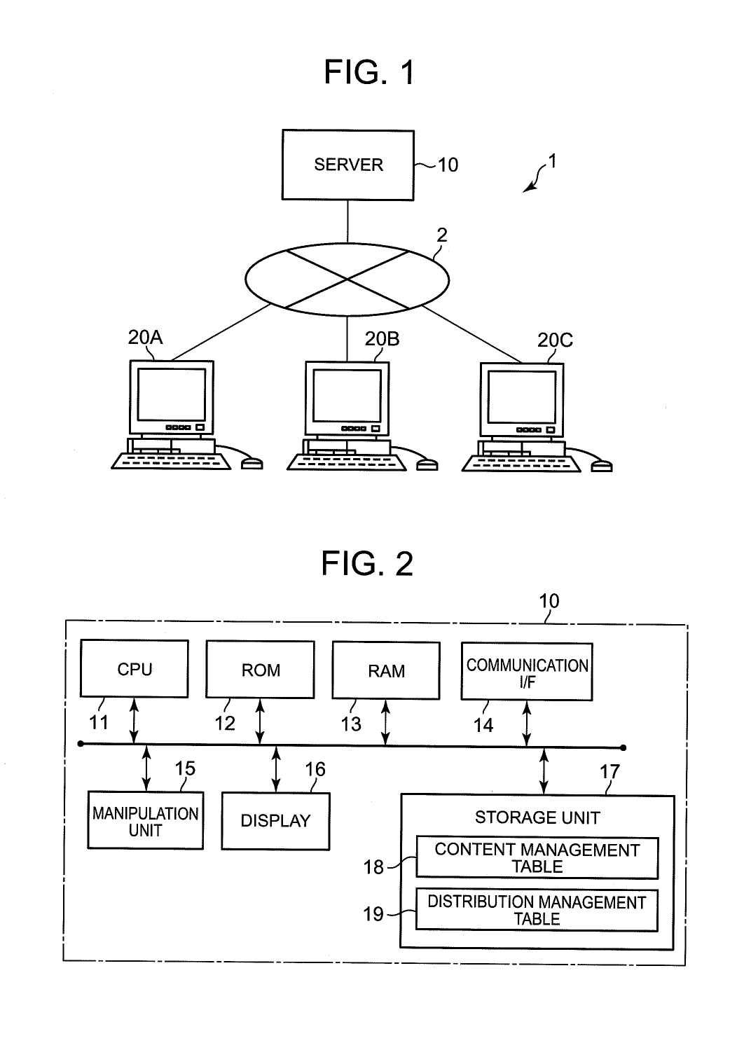

FIG. 1 illustrates a configuration of a content transaction system 1 according to an embodiment of the invention. The content transaction system 1 includes a server 10 (an exemplary content management apparatus) and a plurality of client devices 20. FIG. 1 shows client devices 20A, 20B and 20C from among the plurality of client devices 20. The server 10 and the client devices 20 are connected through a communication network 2 such as the Internet.

FIG. 2 illustrates a configuration of the server 10. The server 10 includes a CPU (Central Processing Unit) 11, a ROM (Read Only Memory) 12, a RAM (Random Access Memory) 13, a communication interface (communication I/F) 14, a manipulation unit 15, a display 16, and a storage unit 17. The CPU 11 controls the components of the server 10 by executing a program. The ROM 12 is a read-only memory that stores a basic system program executed by the CPU 11. The RAM 13 is a volatile memory used as a work area by the CPU 11. The communication interface 14 controls data communication between the server 10 and the client devices 20. The manipulation unit 15 includes a keyboard and a mouse, for example. The manipulation unit 15 provides a manipulation signal in response to manipulation of a user to the CPU 11. The display 16 is a liquid crystal display, for example. The display 16 displays various images under the control of the CPU 11. The storage unit 17 may be a hard disk, for example. The storage unit 17 stores a content management table 18 and a distribution management table 19. In addition, the storage unit 17 stores data necessary to process sounds.

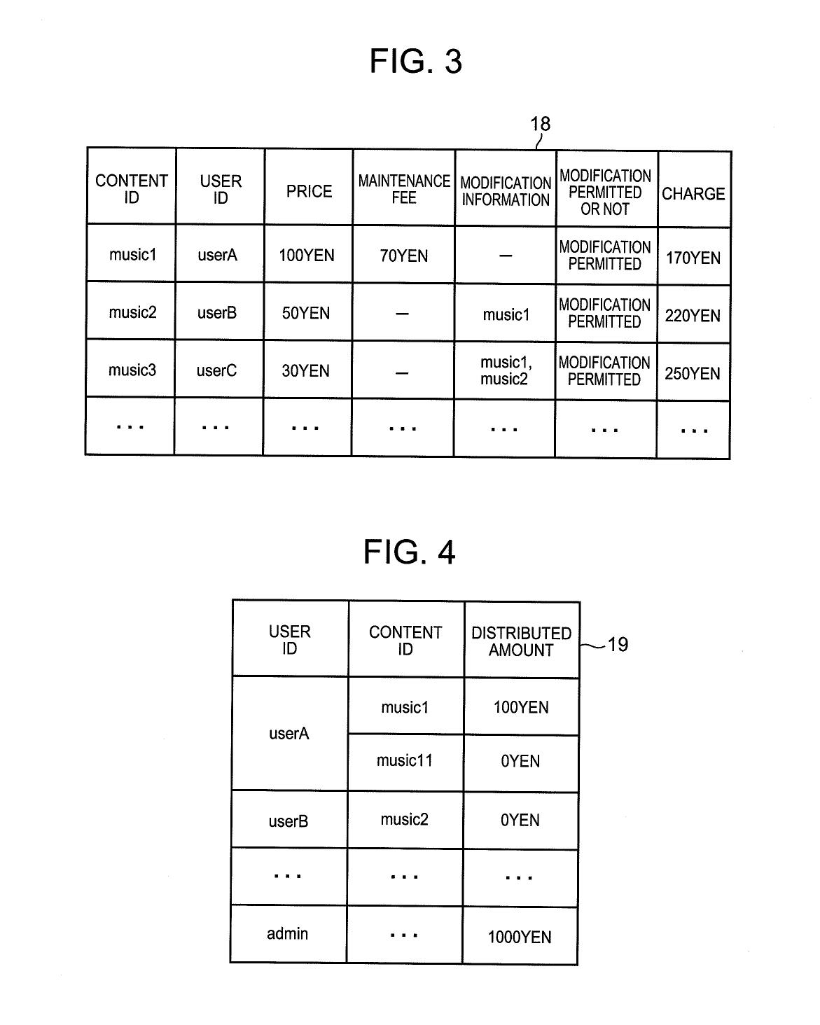

FIG. 3 shows an example of the content management table 18. The content management table 18 contains content ID, user ID, price information indicating a price, maintenance fee information indicating a maintenance fee, modification information, information representing whether modification is permitted, and charge information indicating a charge. The content ID is content identification information that identifies content. The user ID is information that identifies a user. The price is set for content by a creator of the content. The maintenance fee is a fee for an administrator who administrates the server 10. The modification information represents whether content is a modification of other content. When the content is not a modification of other content, “−” is stored in the content management table 18. When the content is a modification of other content, content ID of the other content is stored in the content management table 18. The other content includes not only content corresponding to a direct modification source but also content corresponding to an indirect modification source. For example, if content C1 is modified to produce content C2 and the content C2 is modified to create content C3, the content ID of the content C1 and the content ID of the content C2 are stored as modification information. The information representing whether modification is permitted indicates whether content modification is permitted or not. When content modification is permitted, information representing that “modification is permitted” is stored. When content modification is not permitted, information indicating that “modification is not permitted” is stored. The charge is an amount charged to a user who purchases content.

FIG. 4 shows an example of the distribution management table 19. The distribution management table 19 contains user ID, content ID and information indicating a distributed amount. The user ID and content ID correspond to those stored in the aforementioned content management table 18. However, user ID “admin” that indicates the administrator of the server 10 is previously stored in the distribution management table 19. The distributed amount is an earning or share allocated to a creator or administrator of content when the content is purchased.

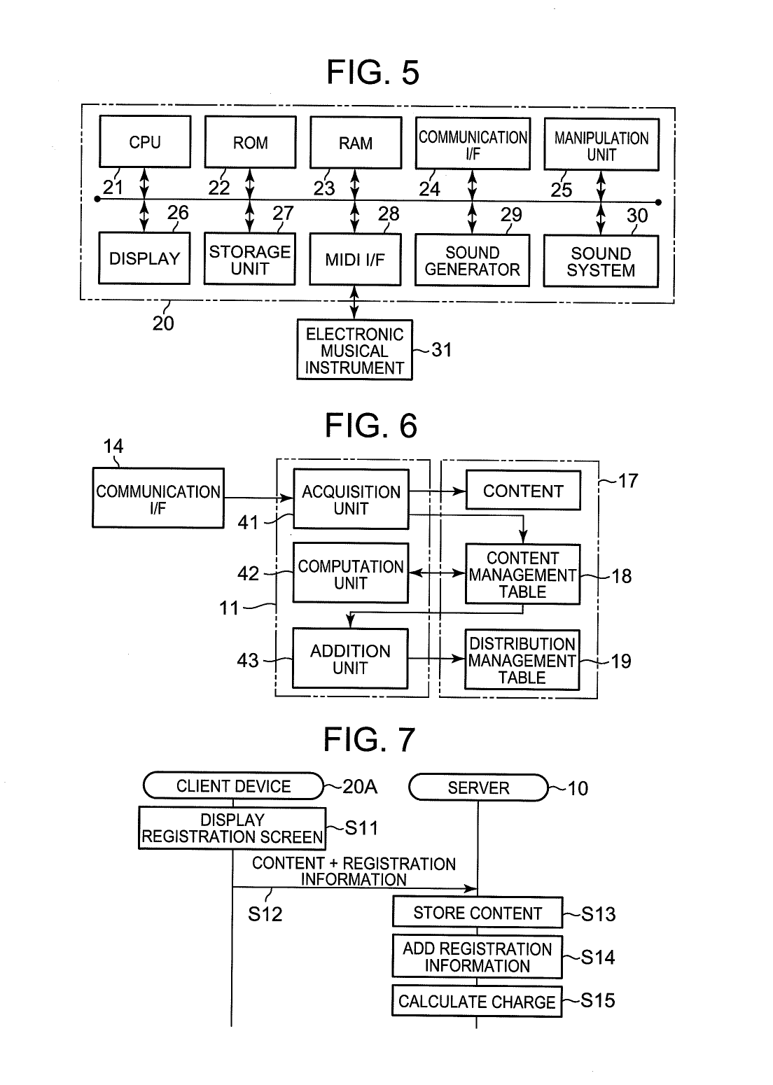

FIG. 5 illustrates a configuration of the client device 20. The client device 20 includes a CPU 21, a ROM 22, a RAM 23, a communication interface (communication I/F) 24, a manipulation unit 25, a display 26, a storage unit 27, a MIDI interface (MIDI I/F) 28, a sound generator 29, and a sound system 30. The CPU 21 controls the components of the client device 20 by executing a program. The ROM 22 is a read-only memory that stores a basic system program executed by the CPU 21. The RAM 23 is a volatile memory used as a work area by the CPU 21. The communication interface 24 controls data communication between the client device 20 and the server 10. The manipulation unit 25 includes a keyboard and a mouse, for example. The manipulation unit 25 provides a manipulation signal in response to user manipulation to the CPU 21. The display 26 may be a liquid crystal display, for example. The display 26 displays various images under the control of the CPU 21. The storage unit 27 may be a hard disk, for example. The storage unit 27 stores various types of data. The MIDI interface 28 controls exchange of a MIDI signal between the client device 20 and an electronic musical instrument 31. The sound system 30 includes a D/A converter, an amplifier and a speaker. The D/A converter converts digital data supplied from the CPU 21 into an analog signal and outputs the analog signal. The amplifier amplifies the analog signal output from the D/A converter. The speaker converts the analog signal amplified by the amplifiers into a sound and outputs the sound.

FIG. 6 illustrates a functional configuration of the CPU 11 of the server 10. The CPU 11 includes an acquisition unit 41, a computation unit 42, and an addition unit 43. This configuration is implemented by executing a program by the CPU 11. The acquisition unit 41 acquires content itself identification information identifying content created by a creator, price information indicating a price set for the content, and modification information that indicates whether the content is a modification of other content. The computation unit 42 calculates a charge based on the price corresponding to the acquired content and stored in the content management table 18 and stores charge information indicating the calculated charge in the content management table 18 such that the calculated charge solely corresponds to the acquired content when the modification information acquired by the acquisition unit 41 indicates that the acquired content is not a modification of other content. The computation unit 42 calculates the sum of a charge corresponding to the other content and stored in the content management table 18 and the price corresponding to the acquired content and stored in the content management table 18 as a charge, and stores the calculated charge in the content management able 18 such that the calculated charge corresponds to the acquired content when the modification information acquired by the acquisition unit 41 indicates that the acquired contents is a modification of the other content. When content stored in the storage unit 17 is used, the addition unit 43 adds a price corresponding to the content stored in the storage unit 17 and stored in the content management table 18 to a distributed amount corresponding to the used content and stored in the distribution management table 19. Here, the use of content includes various modes described later such as transmission of content, alteration or modification of content, and reproduction or play of content. In addition, when modification information which corresponds to the used content and is stored in the content management table 18 indicates that the used content is a modification of other content, the addition unit 43 adds a price corresponding to the other content and stored in the content management table 18 to a distributed amount corresponding to the other content and stored in the distribution management table 19.

### 2. Operation

(1) Registration

Upon creating original content, a user (namely, creator) registers the created content in the server 10 to release the content to other users. The “original content” means content created by the user.

FIG. 7 is a sequence chart illustrating a content registration procedure. It is assumed that a user A (an example of a creator) who uses the client device 20A creates music content m1 using the electronic musical instrument 31 and the manipulation unit 25. The user A instructs the client device 20A to access the server 10 using the manipulation unit 25 of the client device 20A. The client device 20A accesses the server 10 according to the instruction of the user A and displays a registration screen 50 provided by the server 10 through the display 26 (step S11).

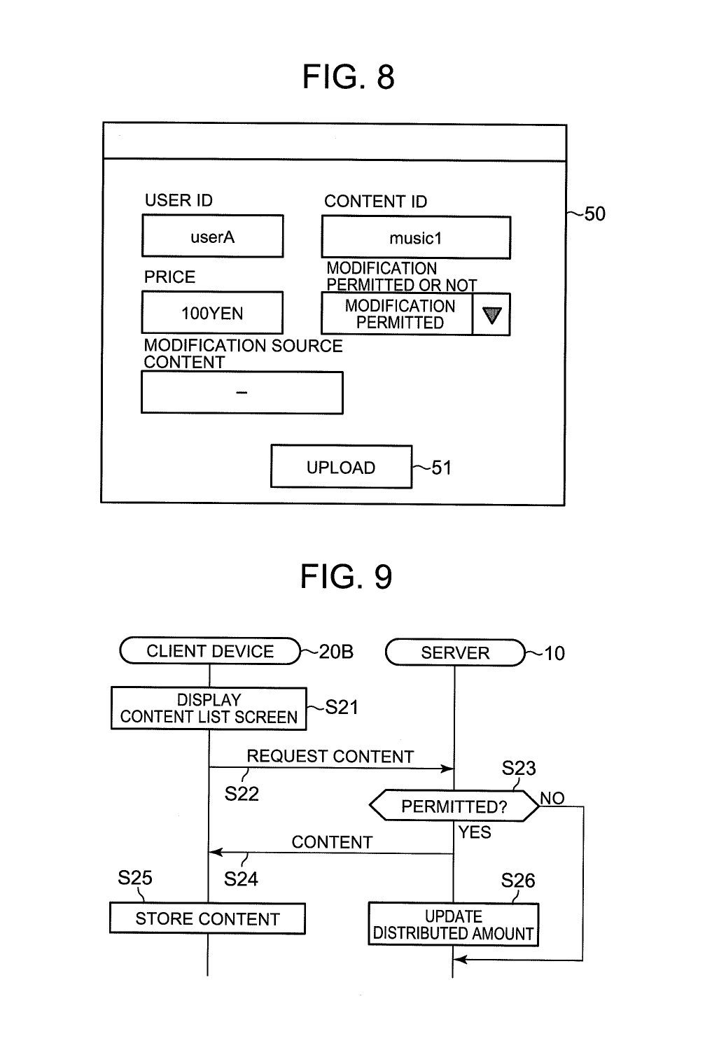

FIG. 8 shows an example of the registration screen 50. Registration information necessary to register content is input through the registration screen 50. Upon display of the registration screen 50, the user A inputs his/her user ID “userA” and content ID of the content m1, “music1” using the manipulation unit 25. In addition, the user A inputs a price of the content m1 and information indicating whether modification is permitted or not using the manipulation unit 25. The price of the content m1 may be a predetermined amount or free (0 yen). It is assumed that “100 yen” is input as the price and information indicating that modification is permitted is input. The user A inputs modification information about the content m1 using the manipulation unit 25. The content m1 is original content of the user A and is not a modification of other content. In this case, information “−” that indicates that the content m1 is not a modification of other content is input. After inputting the registration information, the user A selects the content m1 and presses an upload button 51.

Referring back to FIG. 7, when the upload button 51 is pressed, the client device 20A transmits the content m1 and the input registration information to the server 10 (step S12). The registration information includes the user ID “userA”, content ID “music1”, price “100 yen”, modification information “−”, and information indicating modification is permitted “modification permitted”.

Upon receiving the content m1 and the registration information from the client device 20A, the CPU 11 of the server 10 stores the content m1 in the storage unit 17 (step S13). In addition, the CPU 11 adds the content m1 and the registration information to the content management table 18 and the distribution management table 19 (step S14). Specifically, the CPU 11 stores the user ID, content ID, price, modification information and information indicating modification is permitted, which are included in the received registration information, in the content management table 18 in such a manner that the user ID, content ID, price, modification information and information indicating modification is permitted correspond to one another. Accordingly, the user ID “userA”, content ID “music1”, price “100 yen”, modification information “−” and information indicating modification is permitted “modification permitted” are stored corresponding to one another, as shown in FIG. 3. Furthermore, the CPU 11 stores the user ID, content ID and distributed amount in the distribution management table 19 in such a manner that the user ID, content ID and distributed amount correspond to one another. Here, the stored distributed amount is an initial value of “0 yen”. Accordingly, the user ID “userA”, content ID “music1” and distributed amount “0 yen” are stored corresponding to one another. Since the content ID “music1” is for identification of the content m1, various information corresponding to the content ID “music1” is stored in such a manner that the various information corresponds to the content m1 through the content ID.

The CPU 11 calculates a charge for the content m1 using the content management table 18 (step S15). Specifically, the CPU 11 determines whether a maintenance fee is added or not on the basis of the content management table 18. The content management table 18 shown in FIG. 3 stores the content ID “music1” of the content m1, modification information “−”, and price “100 yen”, which correspond to one another. This represents that the content m1 is original content and the price of the content m1 is a predetermined amount. In this case, the CPU 11 determines that the maintenance fee should be added and stores a maintenance fee “70 yen” corresponding to the content ID “music1” of the content m1. Subsequently, the CPU 11 extracts the stored price “100 yen” corresponding to the content ID “music1” of the content m1 and the maintenance fee “70 yen” from the content management table 18, and calculates the sum of the extracted price “100 yen” and maintenance fee “70 yen”, that is 170 yen, as a charge. Namely, the CPU 11 calculates the sum of the price and the maintenance fee as a charge when the modification information acquired from the client device 20 indicates that the content acquired from the client device 20 is not a modification of other content and the price corresponding to the acquired content and being stored in the content management table 18 is a predetermined amount. In addition, the CPU 11 stores the calculated charge “170 yen” in the content management table 18 in such a manner that the calculated charge corresponds to the content ID “music1”.

(2) Purchase Procedure

Users can purchase content registered in the server 10. It is assumed that a user B who uses the client device 20B buys the content m1 created by the user A.

FIG. 9 is a sequence chart illustrating a content purchase process. The user B instructs the client device 20B to access the server 10 using the manipulation unit 25 of the client device 20B. The client device 20B accesses the server 10 according to the instruction of the user B and displays a content list screen 60 provided by the server 10 through the display 26 (step S21).

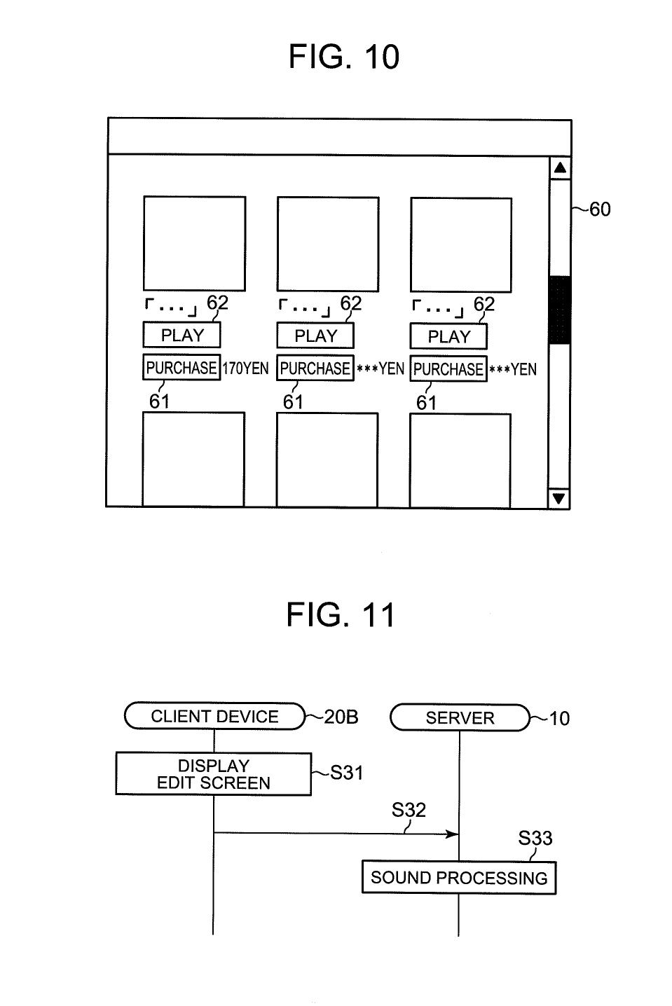

FIG. 10 shows an example of the content list screen 60. The content list screen 60 displays contents registered in the server 10 and their charges stored in the content management table 18. Upon display of the content list screen 60, the user B selects the content m1 created by the user A and presses a purchase button 61 using the manipulation unit 25.

Referring back to FIG. 9, when the purchase button 61 is pressed, the client device 20B requests the server 10 to provide the content m1 (step S22). Upon the request of the client device 20B, the CPU 11 of the server 10 determines whether modification of the content m1 is permitted on the basis of the content management table 18 (step S23). The content management server 18 shown in FIG. 3 stores the content ID “music1” of the content m1 and the information indicating that modification is permitted, “modification permitted”, which correspond to each other. In this case, the CPU 11 determines that modification of the content m1 is permitted (step S23: YES). When modification of the content m1 is permitted, the CPU 11 duplicates the content m1 stored in the storage unit 17 and transmits the duplicated content m1 to the client device 20B (step S24). Upon receiving the content m1 from the server 10, the client device 20B stores the received content m1 in the storage unit 27 (step S25).

When the content ID “music1” and information indicating that modification is not permitted, “modification not permitted”, which correspond to each other, are stored in the content management table 18, the CPU 11 determines that modification of the content m1 is not permitted (step S23: NO). In this case, the CPU 11 does not transmit the content m1 in step S24.

When the user B buys the content m1 in this manner, the user B is charged for the content m1 on the basis of the charge information “170 yen” corresponding to the content ID “music1” of the content m1, which is stored in the content management table 18. In this process, a bill is issued or payment via a credit card is performed, for example. Here, the CPU 11 may extract the charge information “170 yen” corresponding to the content ID “music1”, stored in the content management table 18, and display the charge on the display 16.

When the content m1 is purchased, the CPU 11 updates the distributed amount stored in the distribution management table 19 (step S26). Specifically, the CPU 11 determines whether the content m1 is a modification of other content on the basis of the modification information stored in the content management table 18. As described above, the content management table 18 shown in FIG. 3 stores the content ID “music1” of the content m1 and modification information “−” which correspond to each other. This represents that the content m1 is not a modification of other content. In this case, the CPU 11 extracts the price information “100 yen” corresponding to the content ID “music1” of the content m1 from the content management table 18 shown in FIG. 3. Then, the CPU 11 adds the extracted price “100 yen” to the distributed amount “0 yen” which corresponds to the content ID “music1” of the content m1 and is stored in the distribution management table 19. That is, when the content stored in the storage unit 17 is purchased, the CPU 11 adds the price corresponding to the purchased content to the distributed amount corresponding to the purchased content. Accordingly, the user ID “userA” of the user A, the content ID “music1” of the content m1 and the distributed amount “100 yen” are stored in such a manner that they correspond to one another, as shown in FIG. 4.

The CPU 11 determines whether the charge for the content m1 includes a maintenance fee on the basis of the content management table 18. The content ID “music1” of the content m1 and the maintenance fee “70 yen” corresponding thereto are stored in the content management table 18 shown in FIG. 3. This means that the charge for the content m1 includes the maintenance fee. Accordingly, the CPU 11 determines that the charge for the content m1 includes the maintenance fee. In this case, the CPU 11 adds the maintenance fee “70 yen” to the distributed amount corresponding to user ID “admin” of the administrator, which is stored in the distribution management table 19.

At a prescribed timing set to once per month, for example, each creator is paid on the basis of distributed amounts stored in the distribution management table 19. Payment is performed in such a manner that a corresponding distributed amount is transferred to an account of each user. For example, when the user ID “userA” and distributed amount “100 yen” corresponding thereto are stored, as shown in FIG. 4, the user A is paid 100 yen. Here, the CPU 11 may display the distribution management table 19 on the display 16.

(3) Modification of Content

A user can modify purchased content. It is assumed that the user B (an exemplary creator) creates new content m2 by modifying the purchased content m1. “Creation” includes not only creation of content but also modification of other content. Accordingly, a content creator includes a person who modifies content as well as a person who creates content.

FIG. 11 is a sequence chart illustrating a content modification procedure. The user B instructs the client device 20B to access the server 10 using the manipulation unit 25 of the client device 20B. The client device 20B accesses the server 10 according to the instruction of the user B and displays an edit screen 70 provided by the server 10 on the display 26 (step S31).

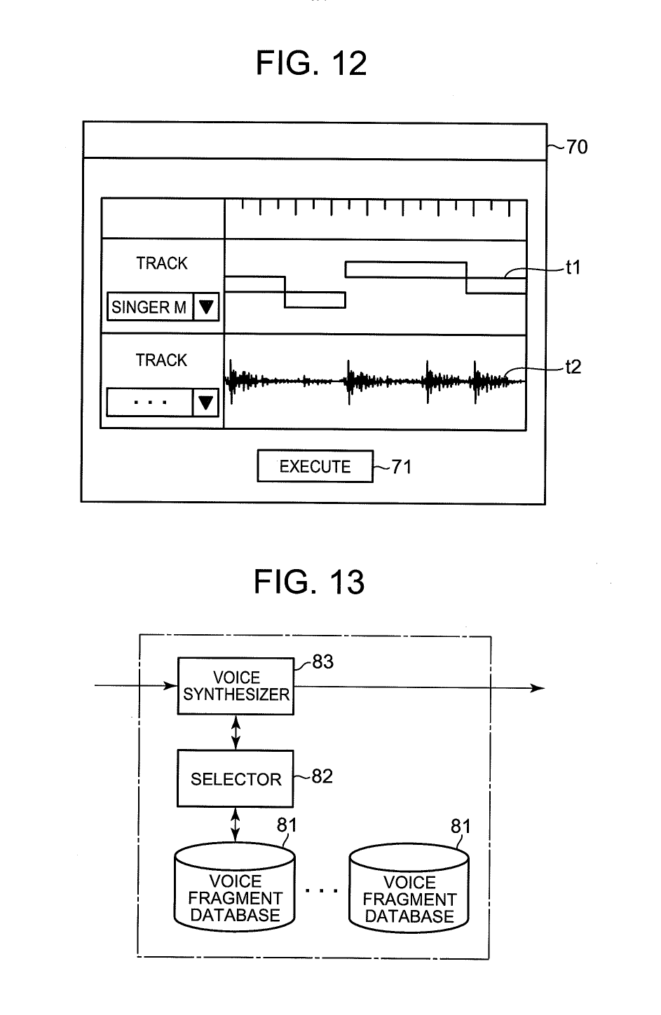

FIG. 12 shows an example of the edit screen 70. Upon display of the edit screen 70, the user B modifies the content m1 using the manipulation unit 25. The content m1 is composed of tracks of score information t1 and tracks of playing information t2. The score information t1 is data in the form of MIDI, which represents scores of music. The score information t1 includes musical notes that constitute the melody of music and data that represents time series of lyrics corresponding to the melody. The playing information t2 is audio data of music. Control data can be set for each track. The control data represents sound processing performed on the track corresponding to the control data. Sound processing includes volume adjustment, effect processing and voice synthesis. It is assumed that the user B changes control data of the tracks of the score information t1 to control data that represents the user B performs voice synthesis according to the voice of a singer M. Then, the user B presses an execute button 71.

Referring back to FIG. 11, when the execute button 71 is pressed, the client device 20B transmits the score information t1 and the changed control data to the server 10 (step S32). Since the playing information t2 is not changed, the playing information t2 is not transmitted to the server 10. Upon receiving the score information t1 and the changed control data from the client device 20B, the CPU 11 of the server 10 performs sound processing indicated by the changed control data on the score information t1 (step S33). Specifically, the CPU 11 performs voice synthesis according to the voice of the singer M on the basis of the score information t1.

FIG. 13 illustrates voice synthesis. The storage unit 17 of the server 10 stores a voice fragment database 81 corresponding to each model singer. The voice fragment database 81 stores a plurality of voice fragments obtained by sampling the voice of each model singer. In addition, the storage unit 17 stores a voice synthesis program. The CPU 11 implements functions of a selector 82 and a voice synthesizer 83 by executing the voice synthesis program. The selector 82 selects the voice fragment database 81 corresponding to the singer M on the basis of the changed control data. The voice synthesizer 83 changes the score information t1 into audio data using the voice fragment database 81 selected by the selector 82. Specifically, the voice synthesizer 83 selects voice fragments from the voice fragment database 81 on the basis of the score information t1, adjusts the pitch and tone of the voice fragments and connects the voice fragments to generate the audio data representing a synthesized singing voice.

In this manner, the content m2 composed of the score information t1 of the content m1 and the changed control data, or the audio data generated according to sound processing and the playing information t2 of the content m1 is generated.

The user B can register the created content m2 in the server 10 by performing the same operation as that of the user A. Specifically, upon display of the registration screen 50 in step S11, the user B inputs registration information of the content m2 using the manipulation unit 25. It is assumed that “userB” is input as the user ID of the user B, “music2” is input as the content ID of the content m2, “50 yen” is input as a price of the content m2, and “modification permitted” is input as the information representing whether modification is permitted. In addition, the user B inputs “music1” corresponding to the content ID of the content m1 as modification information about the content m2 because the user B creates the content m2 by modifying the content m1 created by the user A.

When the content m2 is selected and the upload button 51 is pressed, the same steps as the above-mentioned steps S12, S13 and S14 are performed. Accordingly, the content ID “music2” of the content m2, the user ID “userB”, price “50 yen”, modification information “music1”, and information representing that modification is permitted, “modification permitted”, are stored in the content management table 18, corresponding to one another, as shown in FIG. 3. The user ID “userB”, content ID “music2” and distributed amount “0 yen”, which correspond to one another, are stored in the distribution management table 19, as shown in FIG. 4.

In step S15, the CPU 11 calculates a charge for the content m2 using the content management table 18. Specifically, the CPU 11 determines whether a maintenance fee is added on the basis of the content management table 18. The content ID “music2” of the content m2 and the modification information “music1”, which correspond to each other, are stored in the content management table 18 shown in FIG. 3. In addition, the content ID “music1” of the content m1 and the maintenance fee “70 yen”, which correspond to each other, are stored in the content management table 18 shown in FIG. 3. This represents that the content m2 is a modification of the content m1 and charge for the content m1 includes the maintenance fee. In this case, the CPU 11 determines that the maintenance fee is not added. Then, the CPU 11 extracts the price “50 yen” corresponding to the content ID “music2” of the content m2 and the charge “170 yen” corresponding to the content ID “music1” of the content m1 from the content management table 18 and calculates the sum of the extracted price “50 yen” and the charge “170 yen”, that is “220 yen”, as a charge. Namely, when the modification information acquired from the client device 20B represents that the content acquired from the client device 20B is a modification of other content, the CPU 11 calculates the sum of a charge corresponding to the other content and the price corresponding to the acquired content as a charge. The CPU 11 stores the calculated charge information “220 yen” in the content management table 18 in such a manner that the charge corresponds to the content ID “music2”.

When content corresponding to a modification of other content is registered in the server 10, a user can purchase the modified content. It is assumed that a user C who uses the client device 20C purchases the content m2 created by the user B. The user C can purchase the content m2 by performing the same manipulation as that performed by the user B. Specifically, in step S21, upon display of the content list screen 60, the user C selects the content m2 created by the user B and presses the purchase button 61 using the manipulation unit 25 of the client device 20C. When the purchase button 61 is pressed, the same steps as the aforementioned steps S22 to S25 are performed. When the user C purchases the content m2, the user C is charged “220 yen” on the basis of the charge information “220 yen” corresponding to the contend ID “music2” of the content m2, stored in the content management table 18.

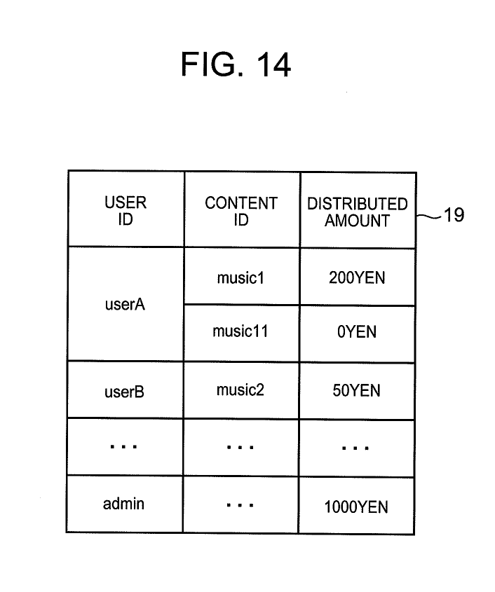

In step S26, the CPU 11 updates the corresponding distributed amount stored in the distribution management table 19 upon purchase of the content m2. Specifically, the CPU 11 determines whether the content m2 is a modification of other content on the basis of modification information stored in the content management table 18. As described above, the content ID “music2” of the content m2 and modification information “music1”, which correspond to each other, are stored in the content management table 18 shown in FIG. 3. This indicates that the content m2 is a modification of the content m1. In this case, the CPU 11 extracts the price information “50 yen” corresponding to the content ID “music2” of the content m2 from the content management table 18. The CPU 11 adds the extracted price “50 yen” to the distributed amount “0 yen” corresponding to the content ID “music2” of the content m2, which is stored in the distribution management table 19. Accordingly, the user ID “userB” of the user B, content ID “music2” of the content m2, and the distributed amount “50 yen”, which correspond to one another, are stored as shown in FIG. 14. The CPU 11 extracts the price information “100 yen” corresponding to the content ID “music1” of the content m1 from the content management table 18 shown in FIG. 3. Then, the CPU 11 adds the extracted price “100 yen” to the distributed amount “100 yen” corresponding to the content ID “music1” of the content m1 and being stored in the distribution management table 19. That is, when the stored modification information corresponding to the purchased content represents that the purchased content is a modification of other content, the CPU 11 adds the stored price corresponding to the other content to the distribution amount corresponding to the other content. Accordingly, the user ID “userA” of the user A, the content ID “music1” of the content m1 and a distributed amount “200 yen” are stored in such a manner that they correspond to one another, as shown in FIG. 14.

Provided that the user C modifies the purchased content m2 to create content m3, sets a price “30 yen” and registers the content m3 in the server 10, a charge for the content m3 amounts to the sum of the charge “220 yen” for the content m2 and the price “30 yen” of the content m3, that is, 250 yen. When the content m3 is purchased, 100 yen is added to the distributed amount corresponding to the content m1, 50 yen is added to the distributed amount corresponding to the content m2, and 30 yen is added to the distributed amount corresponding to the content m3.

According to the above-described embodiments, when content corresponding to a modification of other content is purchased, respective set prices can be distributed to the user who creates the other content and the user who creates the purchased content.

3. Modifications

The present invention is not limited to the above embodiments. The embodiments may be modified as follows. Furthermore, the following modifications may be combined.

(1) Modification 1

In the above embodiments, when a price set for original content is free, a charge for the content may be made free. Provided that the price of the content m1 is “0 yen”, the content ID “music1” of the content m1, the price “0 yen” and modification information “−” are stored in the content management table 18 in such a manner that they correspond to one another. This indicates that the content m1 is not a modification of other content and the content m1 is free. In this case, the CPU 11 sets the charge as “free” in step S15. That is, when content acquired from the client device 20 is not a modification of other content and the stored price information corresponding to the content is “free”, the CPU 11 sets a charge for the content to “free”. When the creator of the original content sets the price of the original content to “free”, a maintenance fee is also set to “free”. Accordingly, the user can use the content for free.

In this case, when a price is set for content corresponding to a modification of free content, a maintenance fee may be added to a charge for the modified content. Provided that the charge for the content m1 is “0 yen” and “50 yen” is set as a price of the content m2 corresponding to a modification of the content m1, the content ID “music2” of the content m2 and modification information “music1”, which correspond to each other, are stored in the content management table 18. In addition, the content ID “music1” of the content m1 and the charge “0 yen”, which correspond to each other, are stored in the content management table 18. This represents that the content m2 is a modification of the content m1 and the charge for the content m1 does not include a maintenance fee. In this case, the CPU 11 calculates the sum of the price “50 yen” of the content m2 and the maintenance fee “70 yen”, that is, “120 yen” as a charge in step S15. That is, when the modification information acquired from the client device 20 represents that content acquired from the client device 20 is a modification of other content, a charge corresponding to the other content and being stored is free, and a price corresponding to the acquired content and being stored is a predetermined amount, the CPU 11 calculates the sum of the price corresponding to the acquired content and being stored and the maintenance fee as a charge.

(2) Modification 2

Content is not limited to a piece of music. For example, when a piece of music is composed of a plurality of tracks, content may be the tracks composing the music. In this case, a user inputs the above-mentioned registration information for each track. Furthermore, processing according to the above embodiments is performed for each track. Accordingly, the user can handle the content on a track by track basis.

Content may be a picture or a combination of a picture and music. Furthermore, content may be an e-book. That is, content can be an object created by a user and electronically traded.

(3) Modification 3

In the above embodiments, when a user purchases content and the content stored in the storage unit 17 of the server 10 is transmitted to the client device 20, the user is charged for the content. However, a target of charging is not limited to transmission of content. For example, even if content is not transmitted from the server 10 to the client device 20, the user can modify the purchased content to create new content in the above embodiments. In this case, when the content on the server 10 is modified, the user may be charged for the content. In the content list screen 60 shown in FIG. 10, content can be played in the client device 20 by selecting the content and pressing a play button 62. Playing the content means output of music from the sound system 30 when the content is music. When the content is a picture or e-book, the act of playing the content means displaying the picture or e-book on the display 26. When playing the content is not free, the user may be charged for the content when the content stored in the storage unit 17 of the server 10 is transmitted to the client device 20 to be played. Here, the amount charged to the user may be calculated by multiplying the amount, which is charged for the content when the content is purchased, by a predetermined rate, or a predetermined amount per play. That is, in the present invention, when a user uses content, the user is charged for using the content and, simultaneously, a distributed amount corresponding to the content is updated. Use of the content may be transmission of the content, modification or playback of the content.

(4) Modification 4

Modification of content is not limited to the examples described in the above embodiments. For example, control data set for a track may be changed to control data representing that a volume level is set to 50%. In this case, the volume level is decreased to 50% in step S33. Alternatively, the control data set for a track may be changed to control data representing that reverberation is applied. In this case, reverberation is applied in step S33. Otherwise, the control data set for a track may be changed to control data representing that the track is converted into audio data in a specific sound generator. In this case, processing for changing the track into audio data in the specific sound generator is performed in step S33. Otherwise, any part of the content may be changed.

(5) Modification 5

The price, charge or distributed amount is not limited to money. For example, the price, charge or distributed amount may be a point having a monetary value. The maintenance fee may not be added. When the maintenance fee is not added, the charge for the original content may be equivalent to the price of the original content. In the above described embodiments, the content management table 18 lists management fee information indicating the fixed management fee of ¥70 for non-free content. However, the amount of management fee is not limited to a fixed amount, but may be set to variable amounts dependent on price of the content or data size of content. Otherwise, the management fee table may list a management fee per content regardless of whether the content is free or non-free. In an alternative mode, the management fee table is configured to set a fixed management fee per user rather than a fixed management fee per content.

(6) Modification 6

The functions of the server 10 may be implemented by a plurality of devices. For example, a first device for storing content and performing sound processing, a second device for administrating the content, and a third device for managing amounts distributed to users may be provided. In this case, the first device performs steps S13, S24 and S33. The second device stores the content management table 18 and performs processing related to the content management table 18 in step S14, and processing of steps S15 and S23. The third device stores the distribution management table 19 and performs processing relating to the distribution management table 19 in step S14, and processing of step S26. These devices can exchange necessary information to cooperate with one another for processing.

(7) Modification 7

The program executed in the CPU 11 of the server 10 or the CPU 21 of the client device 20 may be stored in a machine readable recording non-transitory medium such as a magnetic tape, a magnetic disc, a flexible disc, an optical disc, an optical magnetic disc, a memory, etc. and installed in the server 10 or the client device 20. The program may be downloaded to the server 10 or the client device 20 through a communication line such as the Internet.

(8) Modification 8

While a user inputs a content ID in the above embodiments, the server 10 may provide a content ID. In this case, upon receiving content from the client device 20, the CPU 11 of the server 10 assigns a specific content ID to the content. When the server 10 assigns a specific content ID, it is possible to prevent duplication of the content ID.

While a user inputs modification information in the above embodiments, the server 10 may set the modification information. In this case, when content is modified to create new content according to the above-mentioned content modification process, the CPU 11 of the server 10 records modification history that represents a chain of modification of the content in the storage unit 17. The modification history includes the content ID of the content corresponding to a modification source. Upon receiving content from the client device 20, the CPU 11 determines whether the received content is a modification of other content on the basis of the modification history recorded in the storage unit 17. When the received content is a modification of other content, the CPU 11 sets the content ID of the other content as modification information of the received content. When the server 10 sets the modification information, it is possible to prevent a user from manipulating modification information.

(9) Modification 9

In the above embodiments, content cannot be purchased when information representing whether modification is permitted corresponds to “modification not permitted”. However, content may be purchased only in a case in which the content is only for playback and is not modified.

(10) Modification 10

In the above embodiments, the content management table 18 stores the content ID, user ID, information indicating price of content, information indicating management fee, modification information, and information indicating charge. Alternatively, the content ID may be replaced by link information indicating a path or address (such as URL) to a location at which the content is stored. Further, in an expedient form, link information indicating a link (for example, URL) to a location at which the content is stored may be recorded in addition to the content ID, user ID, price information, management fee information, modification information and charge information.

What is claimed is:

1. A content management apparatus comprising:
an acquisition unit that acquires content identification information identifying content created by a creator, price information indicating a price set for the content, and modification information indicating whether the content is a modification of other content;
a storage unit that stores the content identification information, the price information and the modification information, which are acquired by the acquisition unit, and also stores distributed amount information indicating a distributed amount allocated to the creator who creates the content in such a manner that the content, the price, the modification information and the distributed amount correspond to one another;
a computation unit that calculates, based on the price of the content identified by the content identification information stored in the storage unit, a charge which is charged to a user when the content is used by the user, and that stores charge information indicating the calculated charge in the storage unit in correspondence to the content created by the creator when the modification information acquired by the acquisition unit indicates that the content is not a modification of the other content; and
an addition unit that adds the price of the content to the distributed amount corresponding to the content when the content is used, thereby updating the distributed amount information stored in the storage unit,
wherein, when the modification information acquired by the acquisition unit indicates that the content is a modification of the other content, the computation unit calculates the charge of the content by summing a charge of the other content and the price of the content and stores charge information indicating the calculated charge in the storage unit in correspondence to the content, and
wherein, when the modification information corresponding to the used content indicates that the used content is a modification of other content, the addition unit adds a price of the other content to a distributed amount corresponding to the other content.

2. The content management apparatus according to claim 1, wherein, when the modification information acquired by the acquisition unit indicates that the content is not a modification of the other content and the price corresponding to the content is a predetermined amount, the computation unit calculates the charge of the content by summing the predetermined amount and a predetermined maintenance fee.

3. The content management apparatus according to claim 1, wherein the computation unit sets the charge free when the modification information acquired by the acquisition unit indicates that the content is not a modification of the other content and the price of the content is free.

4. The content management apparatus according to claim 1, wherein the computation unit calculates the charge of the content by summing the price of the content and a predetermined maintenance fee when the modification information acquired by the acquisition unit indicates that the content is a modification of the other content, the charge of the other content is free, and the price of the content is not free.

5. The content management apparatus according to claim 1, wherein the acquisition unit acquires the content identification information identifying content which is music or tracks constituting the music.

6. The content management apparatus according to claim 5, wherein the acquisition unit acquires the content identification information, the price information and the modification information for each of the tracks of the music.

7. The content management apparatus according to claim 1, wherein the acquisition unit acquires the content identification information identifying content which is audio data representing a synthesized voice.

8. The content management apparatus according to claim 7, wherein the acquisition unit acquires the content identification information identifying content which is modified from other content by applying sound processing to the other content.

9. The content management apparatus according to claim 8, wherein the sound processing applied to the other content includes volume adjustment, effect processing and voice synthesis.

10. A content management method comprising:
acquiring content identification information identifying content created by a creator, price information indicating a price set for the content, and modification information indicating whether the content is a modification of other content;
storing acquired ones of the content identification information, the price information and the modification information, and also storing distributed amount information indicating a distributed amount allocated to the creator who creates the content in such a manner that the content, the price, the modification information and the distributed amount correspond to one another;
calculating a charge, which is charged to a user when the content is used by the user, based on the price of the content identified by the content identification information, and storing charge information indicating the calculated charge in correspondence to the content created by the creator when the modification information indicates that the content is not a modification of the other content; and
adding the price of the content to the distributed amount corresponding to the content when the content is used, thereby updating the distributed amount information,
wherein, when the modification information indicates that the content is a modification of the other content, the step of calculating calculates the charge of the content by summing a charge of the other content and the price of the content and storing charge information indicating the calculated charge in correspondence to the content, and
wherein, when the modification information corresponding to the used content indicates that the used content is a modification of other content, the step of adding adds a price of the other content to a distributed amount corresponding to the other content.

11. A content management method comprising:
a first step of acquiring content link information indicating a path to a storage location of content which is created by a creator, price information indicating a price set for the content, and modification information indicating whether the content is a modification of other content;
a second step of storing acquired ones of the link information, the price information and the modification information, and also storing distributed amount information indicating a distributed amount allocated to the creator in such a manner that the content, the price, the modification information and the distributed amount correspond to one another;
a third step of calculating a charge based on the price of the content, the charge being charged to a user when the content is used by the user, and storing charge information indicating the calculated charge in correspondence to the link information when the modification information indicates that the content is not a modification of the other content; and
a fourth step of adding the price of the content to the distributed amount corresponding to the content when the content is used, thereby updating the distributed amount information,
wherein, when the modification information indicates that the content is a modification of the other content, the third step calculates the charge of the content by summing a charge of the other content and the price of the content, and storing the calculated charge in correspondence to the link information of the content, and
wherein, when the modification information corresponding to the used content indicates that the used content is a modification of other content, the fourth step adds a price of the other content to a distributed amount corresponding to link information of the other content.

12. A machine readable non-transitory medium for use in a computer, the medium containing program instructions executable by the computer to perform a content management process comprising:
acquiring content identification information identifying content created by a creator, price information indicating a price set for the content, and modification information indicating whether the content is a modification of other content;
storing acquired ones of the content identification information, the price information and the modification information, and also storing distributed amount information indicating a distributed amount allocated to the creator who creates the content in such a manner that the content, the price, the modification information and the distributed amount correspond to one another;
calculating a charge, which is charged to a user when the content is used by the user, based on the price of the content identified by the content identification information, and storing charge information indicating the calculated charge in correspondence to the content created by the creator when the modification information indicates that the content is not a modification of the other content; and
adding the price of the content to the distributed amount corresponding to the content when the content is used, thereby updating the distributed amount information,
wherein, when the modification information indicates that the content is a modification of the other content, the step of calculating calculates the charge of the content by summing a charge of the other content and the price of the content and storing charge information indicating the calculated charge in correspondence to the content, and
wherein, when the modification information corresponding to the used content indicates that the used content is a modification of other content, the step of adding adds a price of the other content to a distributed amount corresponding to the other content.
